(19) United States
(12) Patent Application Publication
(10) Pub. No.: US 2022/0278365 A1
(43) Pub. Date: Sep. 1, 2022

(54) SOLID-STATE BATTERY

(71) Applicant: Murata Manufacturing Co., Ltd., Nagaokakyo-shi (JP)

(72) Inventor: Osamu CHIKAGAWA, Nagaokakyo-shi (JP)

(21) Appl. No.: 17/748,325

(22) Filed: May 19, 2022

Related U.S. Application Data
(63) Continuation of application No. PCT/JP2021/004987, filed on Feb. 10, 2021.

(30) Foreign Application Priority Data
Feb. 13, 2020 (JP) 2020-022506

(51) Int. Cl. H01M 10/0562; H01M 10/058; H01M 50/141

(52) U.S. Cl. CPC H01M 10/0562; H01M 10/058; H01M 50/141

(57) ABSTRACT

A solid-state battery that includes: a battery element that includes, along a lamination direction, one or more battery constituent units each having a positive electrode layer, a negative electrode layer, and a solid electrolyte layer interposed between the positive electrode layer and the negative electrode layer; an external electrode joined to an end of the battery element; a solder film covering a surface of the external electrode; and a holding terminal that holds the external electrode with the solder film.

### CROSS REFERENCE TO RELATED APPLICATIONS

The present application is a continuation of International application No. PCT/JP2021/004987, filed Feb. 10, 2021, which claims priority to Japanese Patent Application No. 2020-022506, filed Feb. 13, 2020, the entire contents of each of which are incorporated herein by reference.

### FIELD OF THE INVENTION

The present invention relates to a solid-state battery.

### BACKGROUND OF THE INVENTION

Conventionally, secondary batteries that can be repeatedly charged and discharged have been used for various purposes. For example, the secondary battery is used as a power source of an electronic device such as a smartphone or a laptop computer.

In the secondary battery, a liquid electrolyte (electrolytic solution) such as an organic solvent is used as a medium for moving ions. However, the secondary battery using the electrolytic solution has a problem such as leakage of the electrolytic solution. Therefore, there has been developed a solid-state battery that is including a solid electrolyte instead of a liquid electrolyte. The solid-state battery is including a battery element that includes, along a lamination direction, one or more battery constituent units each provided with a positive electrode layer, a negative electrode layer, and a solid electrolyte layer interposed between the positive electrode layer and the negative electrode layer.
Patent Document 1: Japanese Patent Application Laid-Open No. 2015-220107

### SUMMARY OF THE INVENTION

Here, in the solid-state battery, an external electrode may be provided at an end of a battery element that is a constituent element of the solid-state battery, and a plating treatment may be applied to the surface of the external electrode. The external electrode is formed by electrode-paste baking or the like, and minute voids may be present in the external electrode in a micro unit. Hence there is a possibility that a plating solution remains inside the external electrode during the plating treatment. As a result, moisture of the plating solution may enter the inside of the battery element, and the battery may not suitably function as a solid-state battery.

The present invention has been made in view of such circumstances. That is, a main object of the present invention is to provide a solid-state battery capable of suitably preventing entry of moisture into a battery element via an external electrode provided at the end of the battery element.

In order to achieve the above object, one embodiment of the present invention provides a solid-state battery including: a battery element that includes, along a lamination direction, one or more battery constituent units each having a positive electrode layer, a negative electrode layer, and a solid electrolyte layer interposed between the positive electrode layer and the negative electrode layer; an external electrode joined to an end of the battery element; a solder film covering a surface of the external electrode; and a holding terminal that holds the external electrode with the solder film.

According to the solid-state battery in one embodiment of the present invention, it is possible to suitably prevent the entry of moisture into the battery element via the external electrode provided at the end of the battery element.

### BRIEF EXPLANATION OF THE DRAWINGS

FIG. 1 is a sectional view schematically illustrating a solid-state battery according to one embodiment of the present invention.

FIG. 2 is a sectional view schematically illustrating a solid-state battery according to another embodiment of the present invention.

FIG. 3A is a perspective view schematically illustrating an example of a holding terminal including a holder in which a part of a formation surface is discontinuous.

FIG. 3B is a perspective view schematically illustrating an aspect in which an external electrode is inserted into an internal space of the holder of the holding terminal illustrated in FIG. 3A.

FIG. 3C is a sectional view schematically illustrating an aspect in which the external electrode has been inserted into the holder of the holding terminal illustrated in FIG. 3A.

FIG. 3D is a bottom view schematically illustrating an aspect in which the external electrode has been inserted into the holder of the holding terminal along a line I-I′ in FIG. 3C.

FIG. 4A is a perspective view schematically illustrating another example of a holding terminal including a holder in which a part of a formation surface is discontinuous.

FIG. 4B is a perspective view schematically illustrating an aspect in which the external electrode is inserted into an internal space of the holder of the holding terminal illustrated in FIG. 4A.

FIG. 4C is a sectional view schematically illustrating an aspect in which the external electrode has been inserted into the holder of the holding terminal illustrated in FIG. 4A.

FIG. 4D is a bottom view schematically illustrating an aspect in which the external electrode has been inserted into the holder of the holding terminal along a line I-I′ in FIG. 4C.

FIG. 5A is a perspective view schematically illustrating another example of a holding terminal including a holder in which a part of a formation surface is discontinuous.

FIG. 5B is a perspective view schematically illustrating an aspect in which the external electrode is inserted into an internal space of the holder in which a part of the formation surface illustrated in FIG. 5A is discontinuous.

### DETAILED DESCRIPTION OF THE INVENTION

Hereinafter, a “solid-state battery” of the present invention will be described in detail. Although the description will be made with reference to the drawings as necessary, the contents illustrated are only shown schematically and exemplarily for the understanding of the present invention, and the appearance, dimensional ratio, and the like may be different from the actual ones.

The term “solid-state battery” used in the present invention refers in a broad sense to a battery having constituent elements formed of a solid, and refers in a narrow sense to an all-solid-state battery having battery constituent elements (particularly preferably all battery constituent elements) formed of a solid. In a preferred aspect, the solid-state battery in the present invention is a laminated solid-state battery configured such that layers forming a battery constituent unit are laminated with each other, and preferably such layers are formed of a sintered body. Note that the “solid-state battery” includes not only a so-called “secondary battery” that can be repeatedly charged and discharged but also a “primary battery” that can only be discharged. According to a preferred aspect of the present invention, the “solid-state battery” is a secondary battery. The “secondary battery” is not excessively limited by its name but may include, for example, a power storage device and the like.

The term “plan view” in the present specification is on the basis of a form in the case of viewing an object from the upper side or the lower side along a thickness direction based on a direction in which each layer constituting the solid-state battery is laminated. The term “sectional view” used in the present specification is on the basis of a form in the case of viewing an object from a direction substantially perpendicular to the thickness direction based on the direction in which each layer constituting the solid-state battery is laminated (to put it briefly, a form in the case of cutting an object along a plane parallel to the thickness direction). The terms “vertical direction” and “horizontal direction” used directly or indirectly in the present specification correspond to a vertical direction and a horizontal direction in the drawings, respectively. Unless otherwise specified, the same reference numerals or symbols indicate the same members/portions or the same semantic contents. In a preferred aspect, it can be understood that a vertically downward direction (i.e., a direction in which gravity acts) corresponds to a “downward direction”, and a direction opposite thereto corresponds to an “upward direction”.

The various numerical ranges referred to in the present specification are intended to include numerical values of the lower and upper limits themselves, unless otherwise stated. That is, when a numerical range such as 1 to 10 is taken as an example, unless otherwise specified, it may be interpreted as including both the lower limit “1” and the upper limit “10.”

[Configuration of Solid-State Battery]

The solid-state battery is including at least electrode layers of a positive electrode and a negative electrode and a solid electrolyte. Specifically, the solid-state battery is including a battery element provided with a battery constituent unit including a positive electrode layer, a negative electrode layer, and a solid electrolyte interposed therebetween.

In the solid-state battery, each layer constituting the solid-state battery is formed by firing, and the positive electrode layer, the negative electrode layer, the solid electrolyte, and the like form a sintered layer. Preferably, the positive electrode layer, the negative electrode layer, and the solid electrolyte are fired integrally with each other, whereby the battery element forms an integrally sintered body.

The positive electrode layer is an electrode layer containing at least a positive electrode active material. The positive electrode layer may further contain a solid electrolyte. For example, the positive electrode layer is formed of a sintered body containing at least positive electrode active material particles and solid electrolyte particles. In one preferred aspect, the positive electrode layer is formed of a sintered body substantially containing only positive electrode active material particles and solid electrolyte particles. On the other hand, the negative electrode layer is an electrode layer containing at least a negative electrode active material. The negative electrode layer may further contain a solid electrolyte. For example, the negative electrode layer is formed of a sintered body containing at least negative electrode active material particles and solid electrolyte particles. In one preferred aspect, the negative electrode layer is formed of a sintered body substantially containing only negative electrode active material particles and solid electrolyte particles.

The positive electrode active material and the negative electrode active material are substances involved in the transfer of electrons in the solid-state battery. Ions move (conduct) between the positive electrode layer and the negative electrode layer via the solid electrolyte, and electrons are transferred, whereby charge and discharge are performed. Preferably, the positive electrode layer and the negative electrode layer are particularly layers capable of occluding and releasing lithium ions or sodium ions. That is, the solid-state battery is preferably an all-solid-state secondary battery in which lithium ions move between the positive electrode layer and the negative electrode layer via the solid electrolyte to charge and discharge the battery.

(Positive Electrode Active Material)

Examples of the positive electrode active material contained in the positive electrode layer include at least one selected from the group consisting of a lithium-containing phosphate compound having a Na super ionic conductor (NASICON)-type structure, a lithium-containing phosphate compound having an olivine-type structure, a lithium-containing layered oxide, a lithium-containing oxide having a spinel-type structure, and the like. Examples of the lithium-containing phosphate compound having the NASICON-type structure include Li₃V₂(PO₄)₃. Examples of the lithium-containing phosphate compound having the olivine-type structure include LiFePO₄ and LiMnPO₄. Examples of the lithium-containing layered oxide particles include LiCoO₂, LiCo_{1/3}Ni_{1/3}Mn_{1/3}O₂. Examples of the lithium-containing oxide having the spinel-type structure include LiMn₂O₄ and LiNi_{0.5}Mn_{1.5}O₄.

Examples of the positive electrode active material capable of occluding and releasing sodium ions include at least one selected from the group consisting of a sodium-containing phosphate compound having the NASICON-type structure, a sodium-containing phosphate compound having the olivine-type structure, a sodium-containing layered oxide, a sodium-containing oxide having the spinel-type structure, and the like.

(Negative Electrode Active Material)

Examples of the negative electrode active material contained in the negative electrode layer include at least one selected from the group consisting of an oxide containing at least one element selected from the group consisting of Ti, Si, Sn, Cr, Fe, Nb, and Mo, a graphite-lithium compound, a lithium alloy, a lithium-containing phosphate compound having the NASICON-type structure, a lithium-containing phosphate compound having the olivine-type structure, a lithium-containing oxide having the spinel-type structure, and the like. Examples of the lithium alloy include Li—Al. Examples of the lithium-containing phosphate compound having the NASICON-type structure include Li₃V₂(PO₄)₃ and LiTi₂(PO₄)₃. Examples of the lithium-containing phosphate compound having the olivine-type structure include LiCuPO₄. Examples of the lithium-containing oxide having the spinel-type structure include Li₄Ti₅O₁₂.

Examples of the negative electrode active material capable of occluding and releasing sodium ions include at least one selected from the group consisting of a sodium-containing phosphate compound having the NASICON-type structure, a sodium-containing phosphate compound having the olivine-type structure, a sodium-containing oxide having the spinel-type structure, and the like.

In the solid-state battery of the present invention according to a preferred aspect, the positive electrode layer and the negative electrode layer are formed of the same material.

The positive electrode layer and/or the negative electrode layer may contain a conductive additive. Examples of the conductive additive contained in each of the positive electrode layer and the negative electrode layer include at least one of metal materials such as silver, palladium, gold, platinum, aluminum, copper, and nickel, carbon, and the like.

Further, the positive electrode layer and/or the negative electrode layer may contain a sintering additive. Examples of the sintering additive include at least one selected from the group consisting of lithium oxide, sodium oxide, potassium oxide, boron oxide, silicon oxide, bismuth oxide, and phosphorus oxide.

(Solid Electrolyte)

The solid electrolyte is a material capable of conducting lithium ions. In particular, the solid electrolyte constituting a battery constituent unit in the solid-state battery forms a layer in which lithium ions or sodium ions can conduct between the positive electrode layer and the negative electrode layer. It is sufficient that the solid electrolyte be provided at least between the positive electrode layer and the negative electrode layer. That is, the solid electrolyte may be present around the positive electrode layer and/or the negative electrode layer so as to protrude from between the positive electrode layer and the negative electrode layer. Specific examples of the solid electrolyte include a lithium-containing phosphate compound having a NASICON structure, an oxide having the perovskite structure, and an oxide having a garnet-type or garnet-type-like structure. Examples of the lithium-containing phosphate compound having the NASICON structure include LiₓM_{y}(PO₄)₃ (1≤x≤2, 1≤y≤2, and M is at least one selected from the group consisting of Ti, Ge, Al, Ga, and Zr). Examples of the lithium-containing phosphate compound having the NASICON structure include Li_{1.2}Al_{0.2}Ti_{1.8}(PO₄)₃. Examples of the oxide having the perovskite structure include La_{0.55}Li_{0.35}TiO₃. Examples of the oxide having the garnet-type or garnet-type-like structure include Li₇La₃Zr₂O₁₂.

Note that Examples of the solid electrolyte capable of conducting sodium ions include a sodium-containing phosphate compound having the NASICON structure, an oxide having the perovskite structure, and an oxide having the garnet-type or garnet-type-like structure. Examples of the sodium-containing phosphate compound having the NASICON structure include NaₓM_{y}(PO₄)₃ (1≤x≤2, 1≤y≤2, and M is at least one selected from the group consisting of Ti, Ge, Al, Ga, and Zr).

The solid electrolyte may contain a sintering additive. The sintering additive contained in the solid electrolyte may be selected from, for example, the same materials as the sintering additive that may be contained in each of the positive electrode layer and the negative electrode layer.

(Terminal)

A solid-state battery is generally provided with a terminal (e.g., an external electrode). In particular, the terminal is provided on the side of the solid-state battery. Specifically, a terminal on a positive electrode side connected to the positive electrode layer and a terminal on a negative electrode side connected to the negative electrode layer are provided on the sides of the solid-state battery. The terminal of the positive electrode layer is joined to the end of the positive electrode layer, specifically, a lead-out part formed at the end of the positive electrode layer. The terminal of the negative electrode layer is joined to the end of the negative electrode layer, specifically, a lead-out part formed at the end of the negative electrode layer. In one preferred aspect, the terminal preferably contains glass or glass ceramics from the viewpoint of joining the terminal to the lead-out part of the electrode layer. The terminal preferably contains a material having high conductivity. A specific material of the terminal is not particularly limited but may be at least one selected from the group consisting of silver, gold, platinum, aluminum, copper, tin, and nickel.

(Protective Layer)

A protective layer may be generally formed on the outermost side of the solid-state battery and is for electrical, physical, and/or chemical protection. Preferably, the material constituting the protective layer is excellent in insulation property, durability, and/or moisture resistance and is safe environmentally.

The protective layer is a layer that covers the surface of the battery element so that the lead-out parts of the respective electrode layers and the respective external electrodes can be joined to each other. Specifically, the protective layer covers the surface of the battery element so that the lead-out part of the positive electrode layer and the external electrode on the positive electrode side can be joined, and covers the surface of the battery element so that the lead-out part of the negative electrode layer and the external electrode on the negative electrode side can be joined. That is, the protective layer does not cover the entire surface of the battery element without a gap, but covers the battery element such that the lead-out part of the electrode layer (the end of the electrode layer) is exposed so that the lead-out part of the electrode layer of the battery element and the external electrode are joined to each other.

[Characteristic Portions of the Present Invention]

Hereinafter, characteristic portions of the present invention will be described.

The inventors of the present application have extensively studied a configuration capable of suitably preventing entry of moisture into a battery element via an external electrode provided at the end of the battery element in a solid-state battery. As a result, the present invention has been devised having the following technical features.

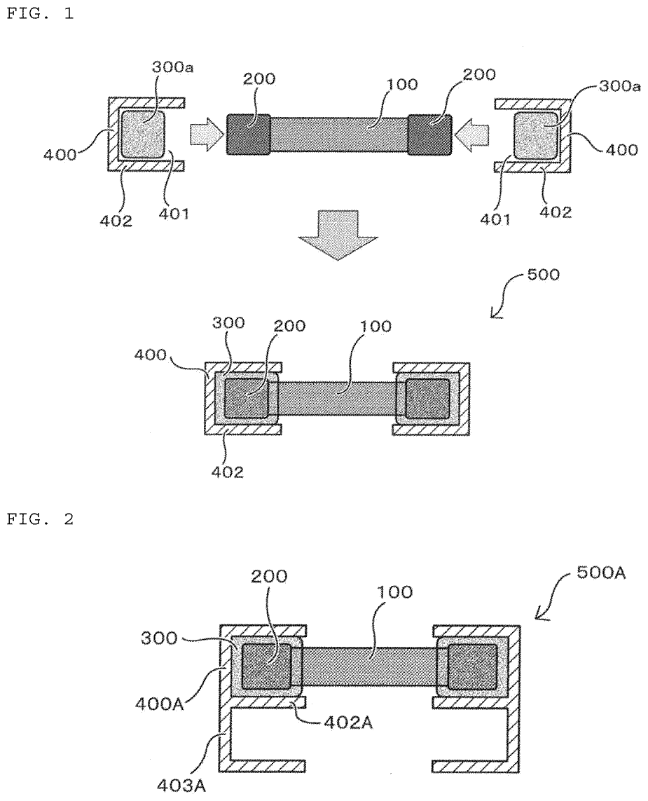

FIG. 1 is a sectional view schematically illustrating a solid-state battery according to one embodiment of the present invention.

As illustrated in FIG. 1, a surface of an external electrode 200 joined to an end of a battery element 100 is covered with a solder film 300, and a holding terminal 400 for holding the external electrode 200 with the solder film 300 is provided.

The external electrode 200 is formed at the end of the battery element 100 by electrode-paste baking or the like, and minute voids may be present in the external electrode 200 in a micro unit. The surface of the external electrode 200 (specifically, the entire surface of the external electrode 200) is covered with the solder film 300 having no or few minute voids, and the holding terminal 400 joined to the solder film is provided so as to surround the solder film 300. As described above, the term “holding terminal” in the present specification contributes to the holding of the external electrode with the solder film, further contributes to the support and/or housing of the external electrode with the solder film, and thus can also be referred to as a support terminal and/or a housing terminal.

Therefore, a plating treatment, specifically a wet plating treatment, is not directly applied to the surface of the external electrode 200. Thus, when the surface of the holding terminal 400 is later plated for electrical connection with an external electronic medium, at least the solder film 300 functions as a water vapor transmission preventing film, so that the plating solution can be suitably prevented from entering the external electrode 200.

For example, the oxygen permeability of the solder film 300 in the thickness direction is, for example, 10⁻³ cc/m²/day/atm or less. The H₂O permeability of the solder film 300 in the thickness direction is, for example, 10⁻⁴ g/m²/day or less. As the H₂O permeability, a value measured at 25° C. by a carrier gas method, a pressure deposition method, or a Ca corrosion method is used.

As a result, it is possible to suitably prevent the moisture of the plating solution from entering the inside of the battery element 100. It is thereby possible to provide battery characteristics of a solid-state battery 500 according to one embodiment of the present invention in a continuous and suitable manner.

As illustrated in FIG. 1, the holding terminal 400 includes a holder 402 having an internal space 401 with an opening constructed to hold the external electrode 200 with the solder film 300. That is, the holding terminal 400 is constructed to cap the external electrode 200.

Note that the solid-state battery 500 according to one embodiment of the present invention having the above characteristics can be obtained by filling the internal space 401 of the holder 402 with a predetermined amount of solder material 300a in advance and by inserting the external electrode 200 provided at the end of the battery element 100 into the internal space 401 in this state and performing heat treatment. The amount of the solder material 300a to fill the internal space 401 of the holder 402 in advance is preferably such an amount that the solder material 300a does not leak from the internal space 401 to the outside after the insertion of the external electrode 200.

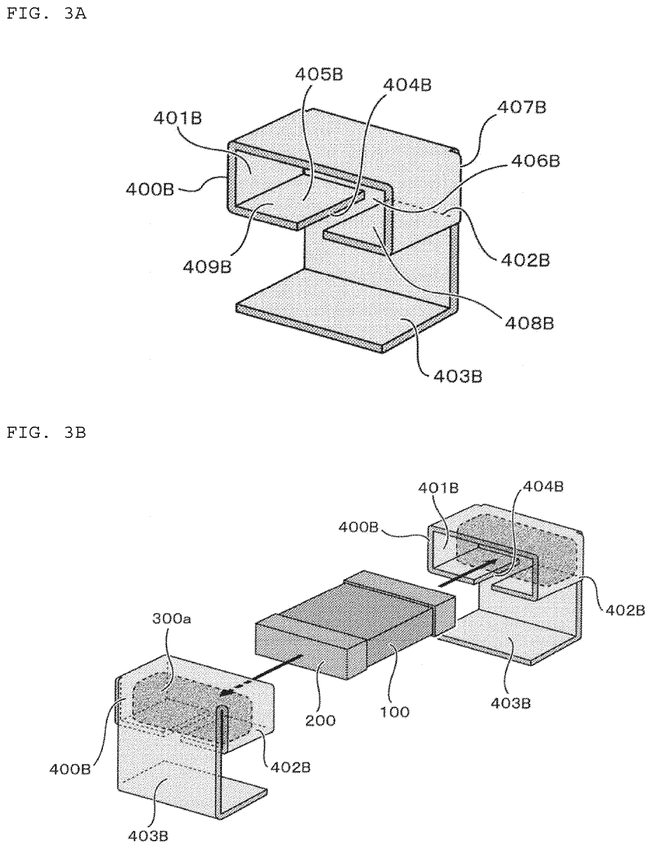

FIG. 2 is a sectional view schematically illustrating a solid-state battery according to another embodiment of the present invention.

The holding terminal is not limited to the configuration illustrated in FIG. 1 but may have a configuration illustrated in FIG. 2. Specifically, a holding terminal 400A can be formed including a holder 402A and a base 403A continuous with the holder 402A and supporting the holder 402A. Due to the presence of the base 403A, the holder 402A can be positioned at a predetermined height.

Thus, when the bottom surface of the base 403A functions as a connection surface with the external electronic medium, the external electronic medium and the holder 402A can be separated along a height direction. As a result, at the time of mounting a solid-state battery 500A on the electronic medium later, it is possible to suitably prevent the solder from coming into contact with the external electronic medium and thereby causing a short circuit failure.

Further, as illustrated in FIG. 2, the base 403A can have an L-shaped cross-sectional shape, for example. In a sectional view, the width of the bottom surface of the base 403A can be substantially the same as the width of the holder 402A. The width here corresponds to a width along a direction in which the battery element 100 extends longitudinally.

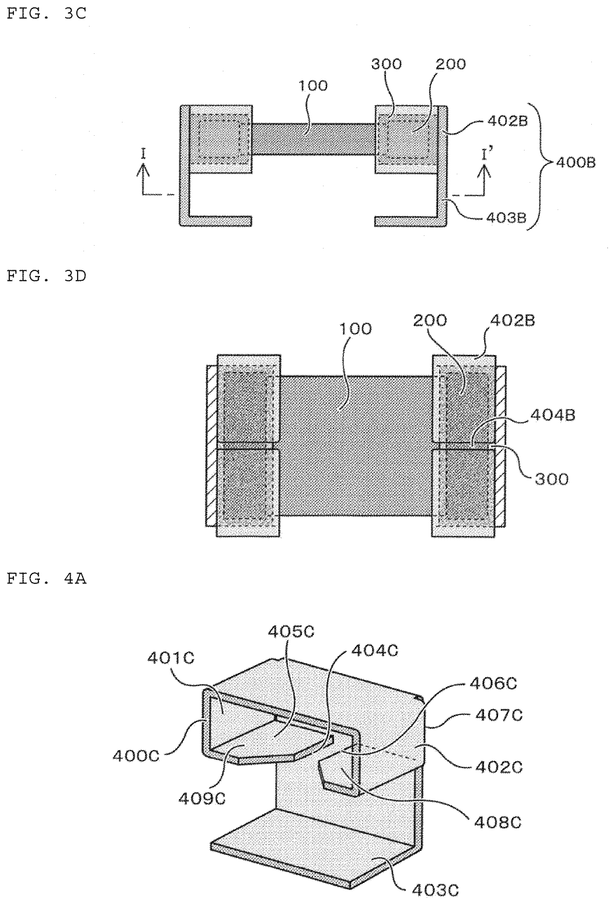

FIG. 3A is a perspective view schematically illustrating an example of a holding terminal including a holder in which a part of a formation surface defining the internal space is discontinuous. FIG. 3B is a perspective view schematically illustrating an aspect in which the external electrode is inserted into the internal space of the holder of the holding terminal illustrated in FIG. 3A. FIG. 3C is a sectional view schematically illustrating an aspect in which the external electrode has been inserted into the holder of the holding terminal illustrated in FIG. 3A. FIG. 3D is a bottom view schematically illustrating an aspect in which the external electrode has been inserted into the holder of the holding terminal along a line I-I′ in FIG. 3C.

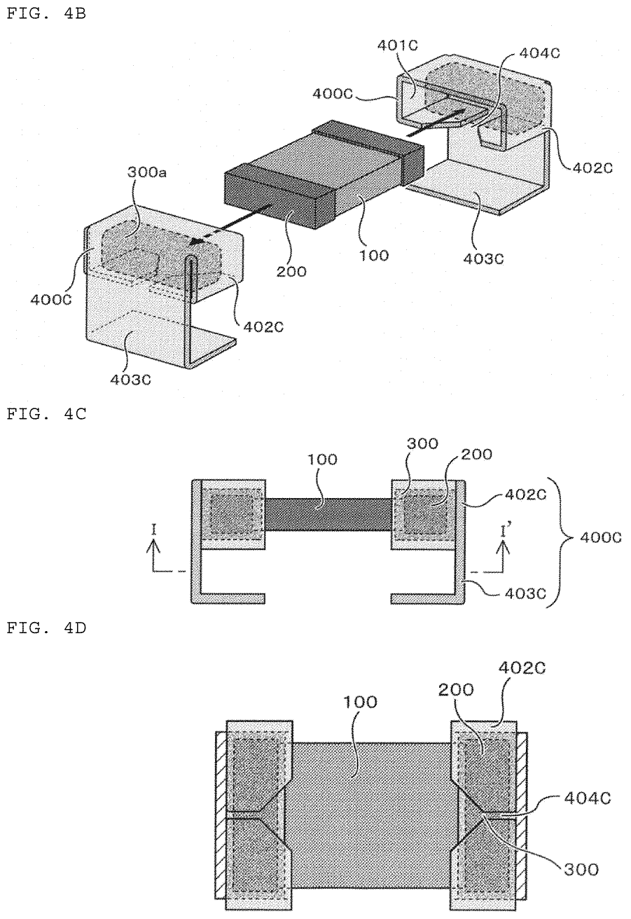

FIG. 4A is a perspective view schematically illustrating another example of a holding terminal including a holder in which a part of a formation surface defining the internal space is discontinuous. FIG. 4B is a perspective view schematically illustrating an aspect in which the external electrode is inserted into the internal space of the holder of the holding terminal illustrated in FIG. 4A. FIG. 4C is a sectional view schematically illustrating an aspect in which the external electrode has been inserted into the holder of the holding terminal illustrated in FIG. 4A. FIG. 4D is a bottom view schematically illustrating an aspect in which the external electrode has been inserted into the holder of the holding terminal along a line I-I′ in FIG. 4C.

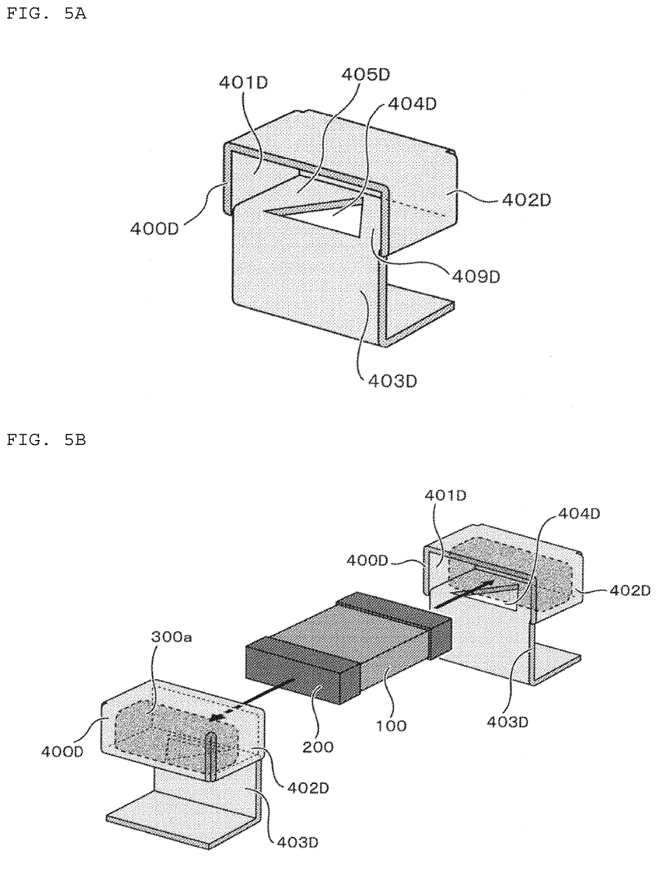

FIG. 5A is a perspective view schematically illustrating another example of a holding terminal including a holder in which a part of a formation surface defining the internal space is discontinuous. FIG. 5B is a perspective view schematically illustrating an aspect in which the external electrode is inserted into the internal space of the holder in which a part of the formation surface illustrated in FIG. 5A is a discontinuous portion.

As described above, the solid-state battery according to one embodiment of the present invention can be obtained by filling the internal space of the holder with a predetermined amount of solder material in advance and by inserting the external electrode into the internal space in this state and performing heat treatment. The amount of the solder material to fill the internal space of the holder in advance is preferably such an amount that the solder material does not leak from the internal space to the outside after the insertion of the external electrode, but it may not be easy to suitably adjust the amount.

More specifically, if the amount of the solder material is larger than a predetermined amount, a part of the solder material may leak from the internal space of the holder toward the outside (specifically, a portion in which the bottom surface of the base is not present and which is located immediately below the battery element).

Therefore, in one embodiment, a part of the formation surface forming the internal space of the holding terminal is discontinuous.

As an example, as illustrated in FIG. 3A, a discontinuous portion 404B can be a gap portion formed between one formation surface 405B and the other formation surface 408B facing each other. The gap portion may extend in one direction from an opening 406B of a holder 402B into the internal space of the holder 402B (i.e., up to a side surface 407B of a holding terminal 400B facing the opening). That is, the gap portion may have a substantially linear shape from the opening 406B of the holder 402B to the side surface 407B of the holding terminal 400B facing the opening.

Similarly to the aspect illustrated in FIG. 2, as illustrated in FIGS. 3A to 3C, a base 403B can have an L-shaped cross-sectional shape, for example. In a sectional view, the width of the bottom surface of the base 403B can be substantially the same as the width of the holder 402B. The width here corresponds to a width along a direction in which the battery element 100 extends longitudinally.

By adopting such a form, when the amount of the solder material 300a having filled an internal space 401B in advance is larger than a predetermined amount, as illustrated in FIG. 3B, at the time of inserting the external electrode 200 into the internal space 401B of the holder 402B of the holding terminal 400B, the solder material located in the internal space 401B can be suitably released to the gap portion.

This makes it possible to suitably avoid a part of the solder material from leaking from the internal space of the holder 402B toward the outside (specifically, a portion in which the bottom surface of the base 403B is not present and which is located immediately below the battery element 100). As a result, at the time of mounting the solid-state battery obtained as illustrated in FIGS. 3C and 3D on the electronic medium later, it is possible to prevent the solder from coming into contact with the electronic medium and thereby causing a short circuit failure. It is also possible to prevent the solder material 300a from leaking from the internal space of the holder 402B to the surface side of the battery element 100.

As another example, as illustrated in FIG. 4A, a discontinuous portion 404C can be a gap portion formed between one formation surface 405C and the other formation surface 408C facing each other. The gap portion may extend in one direction such that at least a part thereof forms a tapered form from an opening 406C of a holder 402C toward the internal space of the holder 402C.

As described above, in the aspect of FIG. 3A, the gap portion may have a substantially linear shape from the opening 406B of the holder 402B to the side surface 407B of the holding terminal 400B facing the opening. In contrast, in the aspect illustrated in FIG. 4A, the region of the gap portion is larger than that in the aspect illustrated in FIG. 3A because the gap portion includes the tapered form. Therefore, as illustrated in FIG. 4B, at the time of inserting the external electrode 200 into an internal space 401C of the holder 402C of a holding terminal 400C, the solder material located in the internal space 401C of the holder 402C can be released more suitably.

In particular, when a wide portion of the tapered form is located on the opening 406C side, and a narrow portion thereof is located inside the holder 402C, a relatively large amount of solder material can be released in the wide portion. Therefore, it is possible to suitably avoid a part of the solder material from leaking toward the outside (specifically, a portion in which the bottom surface of the base is not present and which is located immediately below the battery element).

Thus, at the time of mounting the solid-state battery obtained as illustrated in FIGS. 4C and 4D on the electronic medium later, the solder can be more suitably prevented from coming into contact with the electronic medium and thereby causing a short circuit failure. In addition, the solder material 300a can be more suitably prevented from leaking to the surface side of the battery element 100.

As still another example, as illustrated in FIG. 5A, a discontinuous portion 404D may be a through hole formed in a formation surface 405D (corresponding to a bottom 409D described below) of a holder 402D. The shape of the through hole is not particularly limited but may be a triangle, a circle, a quadrangle, a polygon, or the like. Due to such a through hole formed in the formation surface 405D, as illustrated in FIG. 5B, at the time of inserting the external electrode 200 into an internal space 401D of the holder 402D of a holding terminal 400D, the solder material positioned in the internal space 401D of the holder 402D can be released in a case where the amount of the solder material 300a having filled the internal space 401D in advance is larger than a predetermined amount.

In particular, as illustrated in FIGS. 5A and 5B, it is preferable that the through hole (corresponding to the discontinuous portion 404D) is located inside the opening of the holder 402D. In this case, the space for releasing the solder material is located in front of the opening of the holder 402D. Therefore, the solder material can be suitably released at a time point before the solder material goes out from the solder internal space to the outside (specifically, a portion in which the bottom surface of the base is not present and which is located immediately below the battery element).

Note that the discontinuous portions 404B to 404D described above are preferably provided at bottoms 409B to 409D (i.e., lower formation surfaces) of the holders 402B to 402D from the viewpoint of smoothly releasing the solder material in the direction of gravity.

Although one embodiment of the present invention has been described above, only typical examples of the application range of the present invention have been illustrated. Therefore, a person skilled in the art may easily understand that the present invention is not limited thereto, and various modifications may be made.

The solid-state battery according to one embodiment of the present invention can be used in various fields where power storage is assumed. The solid-state battery according to one embodiment of the present invention can also be used in: the electric, information, and communications fields in which mobile devices and the like are used (e.g., the fields of mobile equipment such as mobile phones, smart phones, smartwatches, laptop computers, digital cameras, activity meters, arm computers, and electronic papers); household and small industrial applications (e.g., the fields of electric tools, golf carts, and household/nursing/industrial robots); large industrial applications (e.g., the fields of forklifts, elevators, and harbor cranes); the transportation system field (e.g., the fields of hybrid vehicles, electric vehicles, buses, trains, power-assisted bicycles, electric two-wheeled vehicles, etc.); power system applications (e.g., the fields of various types of power generation, road conditioners, smart grids, household power storage systems, etc.); medical applications (the field of medical equipment such as earphone hearing aids); medical applications (the fields of dosage management systems, etc.); the Internet of Things (IoT) field; space and deep sea applications (e.g., the fields of space probes, submersible research vessels, etc.), and the like, although these are mere examples.

### DESCRIPTION OF REFERENCE SYMBOLS

500, 500A: Solid-state battery
400, 400A, 400B, 400C, 400D: Holding terminal
401, 401A, 401B, 401C, 401D: Internal space with opening
402, 402A, 402B, 402C, 402D: Holder
403A, 403B, 403C, 403D: Base
404B, 404C, 404D: Discontinuous portion
405B, 405C, 405D: One formation surface
406B, 406C: Opening of holder
407B, 407C: Side surface of holding terminal
408B, 408C: Other formation surface
409B, 409C, 409D: Bottom of holder
300: Solder film
300a: Solder material
200: External electrode
100: Battery element

1. A solid-state battery comprising:
a battery element that includes, along a lamination direction, one or more battery constituent units each having a positive electrode layer, a negative electrode layer, and a solid electrolyte layer interposed between the positive electrode layer and the negative electrode layer;
an external electrode joined to an end of the battery element;
a solder film covering a surface of the external electrode; and
a holding terminal that holds the external electrode with the solder film.

2. The solid-state battery according to claim 1, wherein the solder film is a water vapor transmission preventing film.

3. The solid-state battery according to claim 1, further comprising a plating film on a surface of the holding terminal.

4. The solid-state battery according to claim 1, wherein the holding terminal includes a holder having an internal space with an opening constructed to hold the external electrode with the solder film within the internal space.

5. The solid-state battery according to claim 4, wherein the holding terminal further includes a base continuous with the holder and constructed to support the holder.

6. The solid-state battery according to claim 5, wherein the base has an L-shaped cross-sectional shape.

7. The solid-state battery according to claim 4, wherein a part of a formation surface of the internal space has a discontinuous portion.

8. The solid-state battery according to claim 7, wherein the discontinuous portion is located at a bottom of the holder.

9. The solid-state battery according to claim 7, wherein the discontinuous portion is a gap portion in the formation surface of the holder.

10. The solid-state battery according to claim 7, wherein at least a part of the discontinuous portion is in a tapered form extending from the opening of the holder toward the internal space of the holder, a wide portion of the tapered form is on an opening side of the opening, and a narrow portion of the tapered form is located inside the holder.

11. The solid-state battery according to claim 7, wherein the discontinuous portion is a through hole in the formation surface.

12. The solid-state battery according to claim 1, wherein an oxygen permeability of the solder film is 10⁻³ cc/m²/day/atm or less.

13. The solid-state battery according to claim 12, wherein an H₂O permeability of the solder film is 10⁻⁴ g/m²/day or less.

14. The solid-state battery according to claim 1, wherein an H₂O permeability of the solder film is 10⁻⁴ g/m²/day or less.
